(19) United States
(12) Patent Application Publication
(10) Pub. No.: US 2026/0019171 A1
(43) Pub. Date: Jan. 15, 2026

(54) Efficient Ranging Algorithm for High Accuracy Distance Measurements

(71) Applicant: Silicon Laboratories Inc., Austin, TX (US)

(72) Inventor: Sauli Lehtimaki, Nummela (FI)

(21) Appl. No.: 18/825,703

(22) Filed: Sep. 5, 2024

Related U.S. Application Data
(60) Provisional application No. 63/669,539, filed on Jul. 10, 2024.

(51) Int. Cl. H04B 17/309; H04L 25/02

(52) U.S. Cl. CPC H04B 17/309; H04L 25/0224

(57) ABSTRACT

A system and method for determining the distance between two wireless network devices is disclosed. The present system utilizes an algorithm that relies on power ratio. The power ratio may be calculated as the ratio of the trial signal power to the total signal power. Trial signal power is defined as the signal power associated with a particular distance. This algorithm computes the channel frequency response and uses the phase signal at each frequency and distance to calculate the power ratio and the cumulative power ratio. Based on the slope of the cumulative power ratio curve, the line of sight distance is determined. This approach does not rely on eigenvectors or any prior estimate of the number of signals, and can therefore be computed quickly and efficiently.

This application claims priority of U.S. Provisional Patent Application Ser. No. 63/669,539, filed Jul. 10, 2024, the disclosure of which is incorporated herein by reference in its entirety.

### FIELD

This disclosure describes systems and methods for determining the distance between two wireless network devices, and specifically, using a new ranging algorithm to determine this distance.

### BACKGROUND

The Bluetooth protocol has designed several techniques to implement high accuracy distance measurement (HADM). These include a phase based ranging approach and a round trip time approach. Typically, there are two devices associated with these approaches; an initiator device that initiates the distance measurement and a reflector device, which responds to the initiator device. The distance being measured is the distance between these two devices.

In the round trip time (RTT) approach, each device uses timestamps. Specifically, when a packet is transmitted, the transmitting device records a transmit timestamp. When that packet arrives, a receive timestamp is used by the receiving device.

In the phase based approach, the initiator device determines the incoming phase for signals transmitted at two different frequencies. The phase measured (θᵢₙᵢₜ) at the initiator device may be approximately the difference in phase between the two devices (i.e. Δθᵢᵣ), added to the product 2π*f*(tp), where f is the frequency of the transmitted signal and tp is the trip delay. If this phase is measured at two different frequencies, and the difference is taken, the result is (θᵢₙᵢₜ₁)−(θᵢₙᵢₜ?)=2π*f1*(tp)−2π*f2*(tp), or 2*π*(f1−f2)*(tp). Based on this equation, the trip delay may be calculated and then converted to a distance. This approach may be enhanced through the use of the multiple signal classification (MUSIC) algorithm. The MUSIC algorithm uses this information to generate pseudo-spectrums which may be used to determine the distance between the two devices.

However, these existing algorithms have limitations. For example, the MUSIC algorithm is very computation and memory intensive, which may be problematic for certain devices. Further, the algorithm may also be time consuming, making it difficult to use this algorithm for measuring moving devices.

Consequently, an improved system and method would be beneficial. Further, it would be advantageous if the improved system did not require a large amount of computational processing.

### SUMMARY

A system and method for determining the distance between two wireless network devices is disclosed. The present system utilizes an algorithm that relies on power ratio. The power ratio may be calculated as the ratio of the trial signal power to the total signal power. Trial signal power is defined as the signal power associated with a particular distance. This algorithm computes the channel frequency response and uses the phase signal at each frequency and distance to calculate the power ratio and the cumulative power ratio. Based on the slope of the cumulative power ratio curve, the line of sight distance is determined. This approach does not rely on eigenvectors or any prior estimate of the number of signals, and can therefore be computed quickly and efficiently.

According to one embodiment, a method of calculating a distance between two wireless network devices is disclosed. The method comprises performing a Channel Sounding procedure at a plurality a channel frequency response; of frequencies to obtain autocorrelating the channel frequency response to obtain a autocorrelated channel frequency response; using the autocorrelated channel frequency response to generate a power ratio as a function of distance, wherein power ratio is defined as trial signal power divided by total power of the autocorrelated channel frequency response; computing a cumulative power ratio as a function of distance using the power ratio; identifying a ramp in the cumulative power ratio; and using a slope of the ramp, the power ratio and the cumulative power ratio to determine a distance between the two wireless network devices. In some embodiments, the trial signal power at a first distance is first calculated by de-rotating a phase of a signal path at the first distance from the autocorrelated channel frequency response to obtain a de-rotated frequency response. In certain embodiments, the trial signal power at the first distance is computed by squaring an absolute mean value of the de-rotated frequency response at the plurality of frequencies. In some embodiments, the total power of the autocorrelated channel frequency response is calculated as a mean of an absolute value of the autocorrelated channel frequency response at each of the plurality of frequencies, squared. In some embodiments, the two wireless network devices comprise Bluetooth network devices. In some embodiments, if the slope of the ramp is steep, the distance is defined as a first peak in the power ratio. In certain embodiments, the power ratio is calculated at a plurality of distances and the first peak is defined as a peak having a magnitude greater than a threshold at a smallest distance. In certain embodiments, if the slope of the ramp is steep, the distance is determined using a phase-based approach. In certain embodiments, if the slope of the ramp is not steep, the distance is defined as a smallest distance where the cumulative power ratio exceeds a predetermined threshold.

According to another embodiment, a Bluetooth network is disclosed. The Bluetooth network comprises a reflector device; and an initiator device, comprising: a Bluetooth network interface; a processing unit; and a memory device, wherein the memory device comprises instructions, which when executed by the processing unit, enable the initiator device to: perform a Channel Sounding procedure at a plurality of frequencies to obtain a channel frequency response; autocorrelate the channel frequency response to obtain a autocorrelated channel frequency response; use the autocorrelated channel frequency response to generate a power ratio as a function of distance, wherein power ratio is defined as trial signal power divided by total power of the autocorrelated channel frequency response; compute a cumulative power ratio as a function of distance using the power ratio; identify a ramp in the cumulative power ratio; and use a slope of the ramp, the power ratio and the cumulative power ratio to determine a distance between the reflector device and the initiator device. In some embodiments, the trial signal power at a first distance is first calculated by de-rotating a phase of a signal path at the first distance from the autocorrelated channel frequency response to obtain a de-rotated frequency response. In certain embodiments, the trial signal power at the first distance is computed by squaring an absolute mean value of the de-rotated frequency response at the plurality of frequencies. In some embodiments, the total power of the autocorrelated channel frequency response is calculated as a mean of an absolute value of the autocorrelated channel frequency response at each of the plurality of frequencies, squared. In some embodiments, if the slope of the ramp is steep, the distance is defined as a first peak in the power ratio. In certain embodiments, the power ratio is calculated at a plurality of distances and the first peak is defined as a peak having a magnitude greater than a threshold at a smallest distance. In certain embodiments, if the slope of the ramp is steep, the distance is determined using a phase-based approach. In certain embodiments, if the slope of the ramp is not steep, the distance is defined as a smallest distance where the cumulative power ratio exceeds a predetermined threshold.

According to another embodiment, a method of calculating a distance between two wireless network devices is disclosed. The method comprises performing a Channel Sounding procedure at a plurality of frequencies to obtain a channel frequency response; using the channel frequency response to generate a power ratio as a function of distance, wherein power ratio is defined as trial signal power divided by total power of the channel frequency response; computing a cumulative power ratio as a function of distance using the power ratio; identifying a ramp in the cumulative power ratio; and using a slope of the ramp, the power ratio and the cumulative power ratio to determine a distance between the two wireless network devices. In some embodiments, the trial signal power at a first distance is first calculated by de-rotating a phase of a signal path at the first distance from the channel frequency response to obtain a de-rotated frequency response. In certain embodiments, the trial signal power at the first distance is computed by squaring an absolute mean value of the de-rotated frequency response at the plurality of frequencies. In some embodiments, the total power of the channel frequency response is calculated as a mean of an absolute value of the channel frequency response at each of the plurality of frequencies, squared. In some embodiments, the two wireless network devices comprise Bluetooth network devices. In some embodiments, if the slope of the ramp is steep, the distance is defined as a first peak in the power ratio. In certain embodiments, the power ratio is calculated at a plurality of distances and the first peak is defined as a peak having a magnitude greater than a threshold at a smallest distance. In certain embodiments, if the slope of the ramp is steep, the distance is determined using a phase-based approach. In certain embodiments, if the slope of the ramp is not steep, the distance is defined as a smallest distance where the cumulative power ratio exceeds a predetermined threshold.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a representative initiator device that may estimate distance according to one embodiment;

FIG. 2 shows a network having an initiator device and at least one reflector device according to one embodiment;

FIG. 3A shows an example graph showing power ratio as a function of distance;

FIG. 3B shows the graph of FIG. 3A using autocorrelation;

FIG. 4 shows a flow chart used to calculate the line of sight distance;

FIGS. 5A-5B show the power ratio and cumulative power ratio for a first configuration;

FIGS. 6A-6B show the power ratio and cumulative power ratio for a second configuration; and

FIG. 7 shows a comparison of two cumulative distribution functions showing the error when a plurality of distance measurements are made using a traditional approach and the disclosed approach.

### DETAILED DESCRIPTION

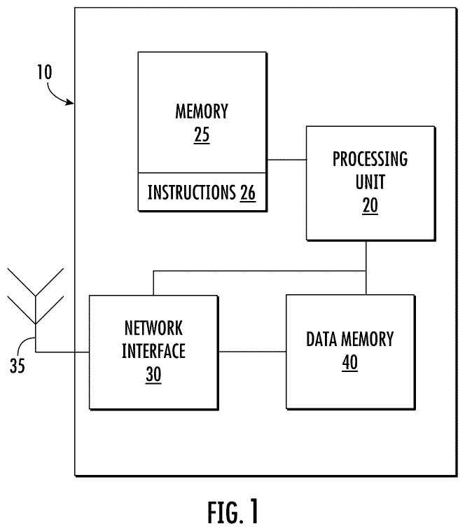

FIG. 1 shows a block diagram of a representative network device. This network device may serve as an initiator device 10, as described in more detail below. This network device may also be used to determine the distance to a remote device, also referred to as a reflector device.

The initiator device 10 has a processing unit 20 and an associated memory device 25. The processing unit 20 may be any suitable component, such as a microprocessor, embedded processor, application specific circuit, a programmable circuit, a an microcontroller, or another similar device. This memory device 25 contains the instructions 26, which, when executed by the processing unit 20, enable the initiator device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

The initiator device 10 also includes a network interface 30, which may be a wireless interface including an antenna element 35.

The wireless signals first enter the network interface 30 through antenna element 35. The antenna element 35 is in electrical communication with a low noise amplifier (LNA). The LNA receives a very weak signal from the antenna element 35 and amplifies that signal while maintaining the signal-to-noise ratio (SNR) of the incoming signal. The amplified signal is then passed to a mixer. The mixer is also in communication with a local oscillator, which provides two phases to the mixer. The cosine of the frequency may be referred to as Iₒ, while the sin of the frequency may be referred to as Qₒ. The Iₒ signal is then multiplied by the incoming signal to create the inphase signal, Iₘ. The Qₒ signal is then multiplied by a 90° delayed version of the incoming signal to create the quadrature signal, Qₘ. The inphase signal, Iₘ, and the quadrature signal, Qₘ, from the mixer are then fed into programmable gain amplifier (PGA). The PGA amplifies the Iₘ and Qₘ signals by a programmable amount. These amplified signals may be referred to as I_{g} and Q_{g}. The amplified signals, I_{g} and Q_{g}, are then fed from the PGA into an analog to digital converter (ADC). The ADC converts these analog signals to digital signals, I_{d} and Q_{d}. These digital signals may then pass through a channel filter. The filtered signals are referred to as I and Q. These I and Q signals can be used to recreate the amplitude and phase of the original signal.

The network interface 30 may support any wireless network, such as Bluetooth, Wi-Fi, networks utilizing the IEEE 802.15.4 specification, such as Zigbee, networks utilizing the IEEE 802.15.6 specification, and wireless smart home protocols, such as Z-Wave. The network interface 30 is used to allow the initiator device to communicate with other devices disposed on the network.

The initiator device 10 may include a data memory device 40 in which data that is received and transmitted by the network interface 30 is stored. This data memory device 40 is traditionally a volatile memory. The processing unit 20 has the ability to read and write the data memory device 40 so as to communicate with the other nodes in the network. Although not shown, the initiator device 10 also has a power supply, which may be a battery or a connection to a permanent power source, such as a wall outlet.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions 26 may be written in any programming language and is not limited by this disclosure. Thus, in some embodiments, there may be multiple computer readable media that contain the instructions described herein. The first computer readable media may be in communication with the processing unit 20, as shown in FIG. 1. The second computer readable media may be a CDROM, or a different memory device, which is located remote from the initiator device 10. The instructions contained on this second computer readable media may be downloaded onto the memory device 25 to allow execution of the instructions by the initiator device 10.

While the processing unit 20, the memory device 25, the network interface 30, and the data memory device 40 are shown in FIG. 1 as separate components, it is understood that some or all of these components may be integrated into a single electronic component. Rather, FIG. 1 is used to illustrate the functionality of the initiator device 10, not its physical configuration.

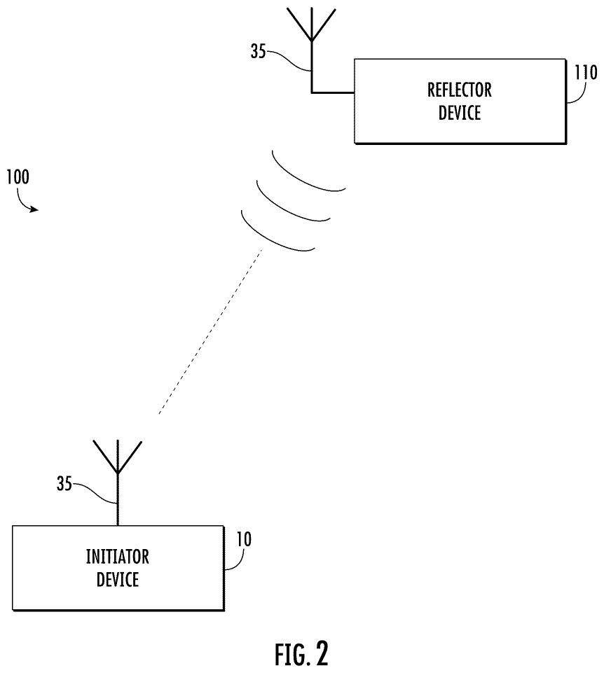

FIG. 2 shows a network 100 having at least one reflector device 110 and an initiator device 10. In certain embodiments, the reflector device 110 may be a network device and contain many of the components described above and shown in FIG. 1. However, the reflector device 110 may have a smaller amount of memory and may have less computational ability.

In FIG. 2, the initiator device 10 may transmit a signal, containing a sine wave having a first frequency to the reflector device 110. In response, the reflector device 110 may transmit signal containing a sine wave having the same first frequency toward the initiator device 10.

In certain embodiments, this signal is transmitted using a network protocol, such as Bluetooth.

The initiator device 10 may utilize the I and Q signals described above to determine the amplitude and phase of the signal arriving at the antenna element 35. This information may then be used to calculate the distance from the initiator device 10 to the reflector device 110.

Specifically, the Bluetooth specification now describes a Channel Sounding procedure, during which the initiator device 10 transmits a first signal at a first frequency to the reflector device 110. The reflector device 110 measures the magnitude and phase of the incoming first signal. In response, the reflector device 110 transmits a second signal having the first frequency back to the initiator device 10. The initiator device 10 measures the magnitude and phase of the incoming second signal. This may be repeated for a number of different frequencies. Based on the magnitude and phase information gathered by the initiator device 10 and the reflector device 110, the channel transfer function (H) may be estimated. Note that the term “channel transfer function” is synonymous with “channel frequency response”.

As a specific example, the Bluetooth specification defines the following procedure to determine the channel transfer function.

First, θ_{CH}(f) represents the phase delay of the channel, where f is the channel frequency, and Δθ_{LO}(f) represents the relative difference in phase of the RF carrier between the initiator device and the reflector device. Based on this, the relative phases of a carrier measured at the reflector and initiator's antenna is θ_{REFL} (f)=θ_{CH}(f)+Δθ_{LO}(f) and θ_{INIT}(f)=θ_{CH}(f)−Δθ_{LO}(f). A_{REFL} (f) and A_{INIT}(f) represent the amplitude of that measured carrier at the reflector and initiator's antenna, respectively. Phase correction term (PCT) is defined by the angle that, if added to the internal angle of the local oscillator, would result in a phase identical to that of the incoming signal. The I and Q values represented by the PCT measured at the reflector and initiator, respectively, are given by PCT_{REFL}(f)=A_{REFL}(f)e^{iθ}_{REFL}(f) and PCT_{INIT}(f)=A_{INIT}(f)e^{iθ}_{INIT}(f). If the communication channel is symmetrical between the initiator device 10 and the reflector device 110, the measured phases are dependent on both the communication channel and the relative difference in phase of the RF carrier between the devices. The communication channel transfer function can then be estimated from

$${H}^{2} ( f ) = {A}_{REFL} ( f ) {e}^{i {θ}_{REFL}} ( f ) \times {A}_{INIT} ( f ) {e}^{i {θ}_{INIT}} ( f ) = {A}_{{CH}^{2}} ( f ) {e}^{i 2 {θ}_{CH}} ( f ) .$$

The channel transfer function (also referred to as channel frequency response) may then be used to compute the distance between the initiator device 10 and the reflector device 110.

First, an autocorrelation of the channel frequency response is computed to improve the signal to noise ratio. In one particular implementation, the autocorrelation of the channel frequency response is performed using the following algorithm:

$${\hat{H}}_{k} = {\sum }_{j = K - k + 1}^{K} {H}_{k + j - K} {H}_{j ,}^{*} if k \leq K$$

$${\hat{H}}_{k} = {\hat{H}}_{2 K - k}^{*} , if K < k \leq 2 K - 1$$

In these equations, Hi refers to the complex conjugate of Hₖ. In other words, if Hₖ=a+bi, then HR=a−bi. In these equations, K represents the number of frequencies used to generate the channel frequency response.

Next, the power of a signal path at a predetermined distance may be estimated by de-rotating the signal path phase from the autocorrelated channel frequency response and assuming that the mean power of all other components will approximate zero.

This can then be used to calculate the power ratio at each distance, x. Specifically, the power ratio may be defined as:

$$φ ( x ) = \frac{{P}_{S} ( x )}{{P}_{H}}$$

where Pₛ(x) is the trial signal power, and P_{H} is the total power of the autocorrelated channel frequency response.

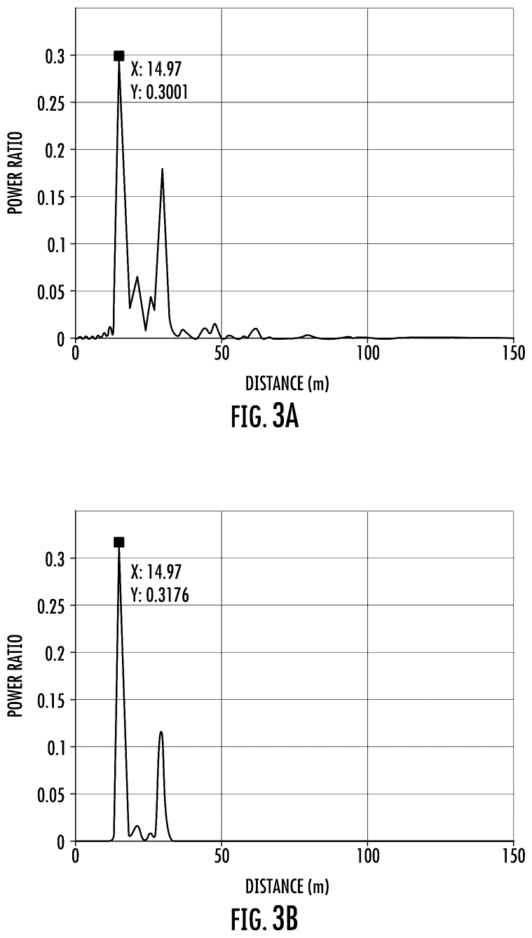

FIG. 3B shows an example spectrum that may be created using this approach. Note that each peak represents a distance at which there is measurable signal power. Note that FIG. 3A shows the example spectrum when the channel frequency response is not autocorrelated first.

The disclosed algorithm creates this spectrum and then determines the line of sight path based on several parameters. Specifically, the algorithm also integrates the spectrum and also uses the slope of the resulting integrated spectrum to determine the line of sight path, as explained below.

The trial signal power may be computed by de-rotating the signal path phase with the autocorrelated channel frequency response, as stated above. The signal path phase may be defined using a fixed matrix, where the columns of that matrix represent different distances and the rows represent different frequencies. This matrix represents the signal path phase at various distances and frequencies.

Thus, D(f,d) is the signal path phase at frequency f at distance d. The values of some of the frequencies used to populate this matrix may be selected to be the same as the frequencies present in the channel frequency response. For example, some of these frequencies may coincide with the frequencies of the various Bluetooth channels. The distances may represent the desired granularity of the measurement. For example, the distance may be set to large numbers (such as 1 meter) if the device is known to be far away, but may be set to a smaller number, such as 5 cm if the device is closer.

The signal path phase at each location in the matrix may be defined as:

$$D ( f , d ) = {e}^{i 2 π fd / c}$$

Further, the trial signal power may be computed by first multiplying the signal path phase by the autocorrelated channel frequency response Ĥ to obtain the de-rotated frequency response. Ĥ is defined as a (2K−1)×1 array, wherein K represents the number of frequencies that were used to compute the channel frequency response. Thus, the de-rotated frequency response, represented by V, may be defined as:

$$V = D ⊗ \hat{H} ,$$

Where ⊗ represents a point-wise multiplication of each element in each column of D with the corresponding element in Ĥ. In other words,

$$V ( f , d ) = D ( f , d ) * \hat{H} ( f )$$

Based on this de-rotated frequency response and the autocorrelated channel frequency response, the power ratio may be computed as follows:

$$φ ( x ) = \frac{{\vert \frac{1}{2 N - 1} {\sum }_{k} V ( k , x ) \vert}^{2}}{\frac{1}{2 N - 1} {\sum }_{k} ( {\vert \hat{H} ( k ) \vert}^{2} )}$$

In this equation,

$${\vert \frac{1}{2 N - 1} {\sum }_{k} V ( k , x ) \vert}^{2}$$

approximates the trial signal power over all frequencies at distance x, and

$$\frac{1}{2 N - 1} {\sum }_{k} ( {\vert \hat{H} ( k ) \vert}^{2} )$$

represents the total power of the autocorrelated channel frequency response. Thus, the power ratio represents the ratio of the power at distance x to the total power. Thus, the summation of the power ratios for distances should be 1, as this will represent the total power as well.

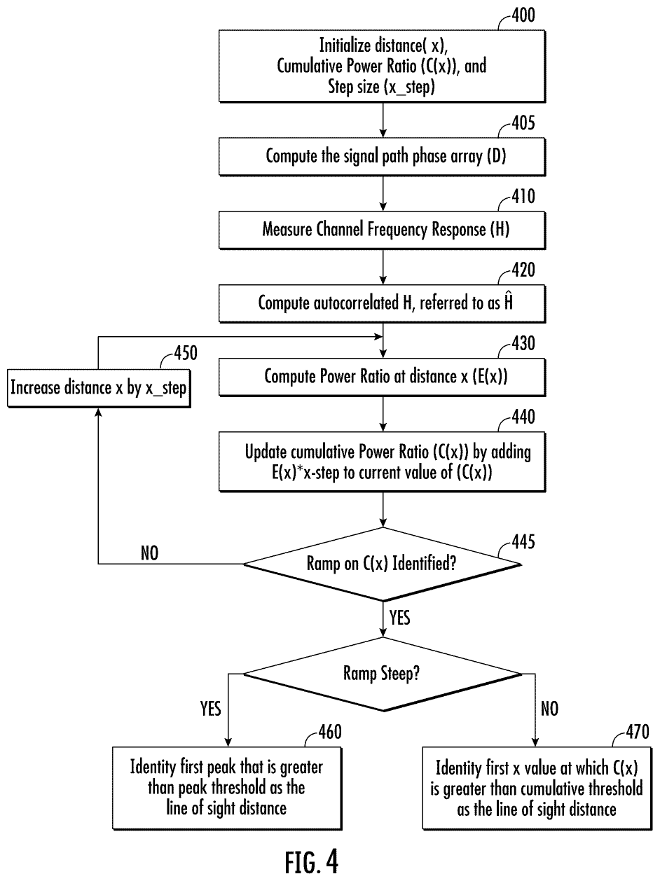

FIG. 4 shows a flow chart that may be used to determine a distance between two devices.

First, as shown in Box 400, several variables are initialized. These include the cumulative power ratio (C(x)), the starting distance (x) and the distance step size (x_step).

Next, as shown in Box 405, the signal path phase at each of the frequencies is calculated and stored in the array D(f,d). Specifically, for each frequency, the signal path phase for each frequency is generated using the equation for D shown above.

As shown in Box 410, the Channel Sounding Procedure is performed and the channel frequency response (H) is calculated based on this procedure.

Next, as shown in Box 420, the autocorrelation of the channel frequency response H, referred as to Ĥ, is computed using the equations described above.

As shown in Box 430, the power ratio at the distance value, x, is then computed. To do this, the phase values of the array D(f,d) (one for each frequency) are multiplied by the autocorrelated channel frequency response at that frequency to create the de-rotated frequency response for the trial signal at each frequency.

Once this has been performed for each frequency, the power of the trial signal can be calculated as the square of the mean value of the de-rotated frequency response for the trial signal across all frequencies. The power ratio can then be calculated using the expression shown below:

$$φ ( x ) = \frac{{\vert \frac{1}{2 N - 1} {\sum }_{k} V ( k , x ) \vert}^{2}}{\frac{1}{2 N - 1} {\sum }_{k} ( {\vert \hat{H} ( k ) \vert}^{2} )}$$

Once the power ratio at a specific distance is determined, this value is then multiplied by the x_step value and added to the cumulative power ratio, as shown in Box 440.

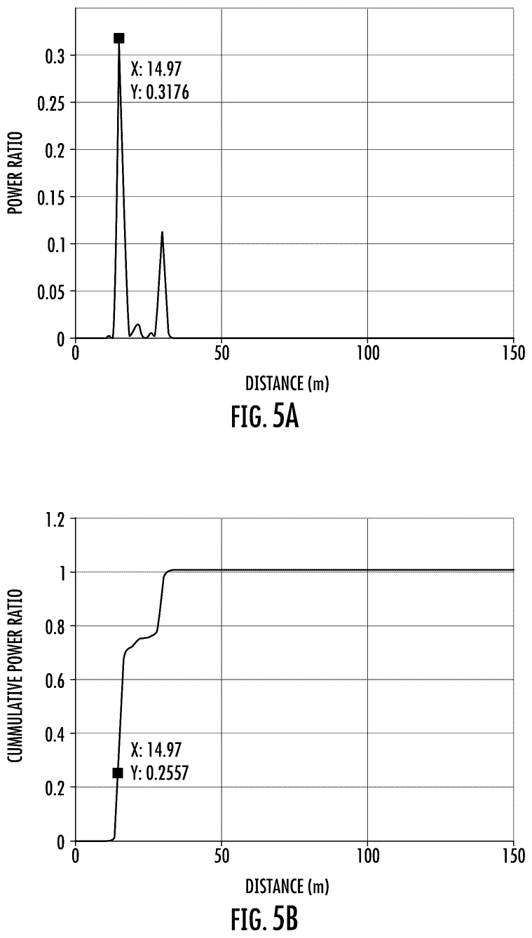

This process then repeats until enough values have been computed to identify the ramp in the cumulative power ratio, as shown in Decision Box 445 and Box 450. The result of these operations are a power ratio curve and a cumulative power ratio curve. Example curves are shown in FIGS. 5A-5B. FIG. 5A shows the power ratio computed for each distance. FIG. 5B is the cumulative power ratio for each distance. Note that the cumulative power ratio is an estimation of the integral of the power ratio curve in FIG. 5A.

A ramp is defined as an upward trend in the cumulative power ratio curve. In certain embodiments, the end of the ramp is defined as the distance, referred to as x_endramp, at which the cumulative power ratio exceeds a predetermined high ramp threshold. This predetermined high ramp threshold may be a fixed value, such as a value between 0.2 and 0.8, and more particularly between 0.3 and 0.5. Alternatively, it may be dynamically varied. To properly define the slope of the ramp, a start of the ramp is also required. In certain embodiments, the start of the ramp, is defined as the distance, referred to as x_startramp, at which the cumulative power ratio exceeds a predetermined low ramp threshold. In certain embodiments, the low ramp threshold may be a fixed value, such as a value between 0.001 and 0.1. The difference between the end distance and the start distance, defined as x_endramp−x_startramp, may be used to determine the steepness of the slope. Specifically, small values of this difference indicate a steep slope, while larger values of this difference indicate a less steep, or more gradual slope. In one embodiment, the difference between the end distance and the start distance is compared against a fixed slope threshold. Differences below this fixed steepness threshold are classified as a steep ramp; differences greater than this fixed steepness threshold are classified as not being a steep ramp. In certain embodiments, the fixed steepness threshold may be between 3 meters and 5 meters, although other values may be used. In some embodiments, the steepness threshold may be related to the values chosen for the low ramp threshold and high ramp threshold. A broader range of threshold ranges may result in a high steepness threshold.

The line of sight distance is computed differently, depending on the steepness of the ramp. As shown in Box 460, if the ramp is steep, the line of sight distance is defined to be the first peak in the power ratio curve that exceeds a predetermined peak threshold. This may be referred to as a type 1 scenario.

In one embodiment, a peak is identified by starting from 0 meters and looking for a power ratio that is smaller than the previous power ratio. If this power ratio is smaller than the previous one, then the previous distance is saved as the peak. Otherwise, the current power ratio is saved as the previous power ratio and the distance is incremented. This process repeats until the peak is found. This peak is then compared to a predetermined peak threshold. If it is greater than that peak threshold, this peak is referred to as the first peak. Thus, the first peak may be defined as the smallest distance that indicated a power ratio greater than a predetermined peak threshold. This peak threshold could be determined empirically or may be a predetermined value. In some embodiments, the peak threshold may be set to a value of 0.1 or greater. If the peak is not greater than the predetermined peak threshold, the process repeats until a first peak is found.

This methodology is seen in FIGS. 5A-5B. Note that the ramp in FIG. 5B is very steep. Thus, in this scenario, the first peak in the power ratio curve, which was found to be at 14.97 meters, is used as the line of sight distance.

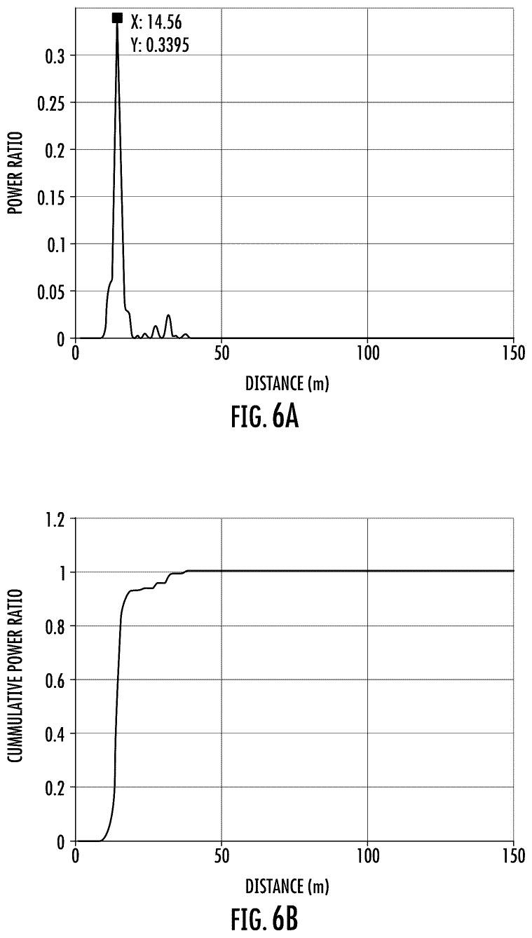

If the ramp is not determined to be steep, a different computation is used to determine the line of sight distance, as shown in Box 470. This may be referred to as a type 2 scenario. For example, FIGS. 6A-6B show the power ratio curve and cumulative power ratio curve for a different environment, respectively. Note that in FIG. 6A, the first peak is wider than that in FIG. 5A, and has a small hump on the left side. This is likely indicative of interference between the actual line of sight distance and a reflection. Consequently, the actual peak associated with the line of sight is likely shifted to the right. Therefore, the technique of simply using the first peak as the line of sight distance may be inaccurate in this situation and may yield a resulting distance that is larger than the actual line of sight distance. Thus, in this situation, the line of sight distance is defined as the distance at which the cumulative power ratio exceeds a cumulative threshold. The value of this cumulative threshold may be selected to be where a significant power increase begins. In some embodiments, the cumulative threshold may be a fixed value, such as between 0.001 and 0.1, although other values may be used. In other embodiments, the cumulative threshold may be dynamically set. For example, the cumulative threshold may be varied in accordance with the steepness of the ramp. For steeper ramps, a larger value of the cumulative threshold may be used, while a smaller value may be used for more gradual slopes.

Note that one advantage of this approach is that the entire spectrum shown in FIG. 3 does not need to be computed to determine the actual distance. Rather, the only calculations performed are those that are at distances that are needed to identify and classify the ramp in the cumulative power ratio curve.

Further, it is noted that the flow chart in FIG. 4 is only one approach to determine the line of sight distance. For example, a different peak detection algorithm may be used. In another embodiment, the peak may be detected by monitoring the gradient and looking for a change in the polarity of the gradient. Additionally, rather than looping over distances, some statistical or Monte Carlo method may be used to select the distances that are to be checked. Of course, other computational optimization techniques, which are well known, may also be used. Additionally, in some embodiments, the autocorrelation may be omitted, such as Box 420 is not executed. In this embodiment, the power ratio, cumulative power ratio and other metrics are calculated using the channel frequency response, rather than the autocorrelated channel frequency response. Furthermore, if it is determined to be a type 1 scenario, a different ranging algorithm may be used. For example, a phase-based approach, such as that described above, may be used to determine the line of sight distance. Furthermore, the MUSIC algorithm may be used with a phase-based approach to determine the line of sight distance.

Note that this computation may be performed by the initiator device 10. The initiator device 10 may contain the requisite computation power and memory space to perform these calculations. Alternatively, the initiator device 10 may off-load the calculations to a computational device (not shown).

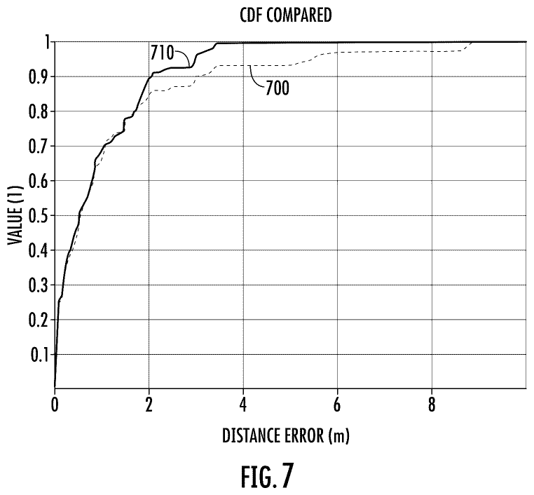

The present system has many advantages. First, this method utilizes a small memory footprint, as few values need to be stored. Second, this algorithm is very fast to compute and does not require the computation of eigenvectors, like some other approaches. This approach is also accurate. FIG. 7 shows the cumulative distribution function for the measurement error when a plurality of measurements were made using a traditional approach and the method of FIG. 4. The distance to be measured varied from 0.5 meters to 70 meters. In this test, the actual distance was known and compared to that calculated using a traditional method, as well as the method shown in the flow chart of FIG. 4 to generate measurement error values. These measurement error values were then used to create this graph. Line 700 shows the cumulative distribution function when a traditional approach is used. Note that the 90th percentile of distance measurement error for the traditional approach is about 3 meters. Further, the 95th percentile is not achieved until a distance of 6 meters. In contrast, note, as shown in line 710, that the 95th percentile of distance measurement error for the entire data set is approximately 3 meters for this new approach. Furthermore, note that for the traditional approach, about 7% of all measurements had a distance measurement error of more than 4 meters, while there were almost no distance measurement errors of this magnitude using the new method.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of calculating a distance between two wireless network devices, comprising:
performing a Channel Sounding procedure at a plurality of frequencies to obtain a channel frequency response;
autocorrelating the channel frequency response to obtain a autocorrelated channel frequency response;
using the autocorrelated channel frequency response to generate a power ratio as a function of distance, wherein power ratio is defined as trial signal power divided by total power of the autocorrelated channel frequency response;
computing a cumulative power ratio as a function of distance using the power ratio;
identifying a ramp in the cumulative power ratio; and
using a slope of the ramp, the power ratio and the cumulative power ratio to determine a distance between the two wireless network devices.

2. The method of claim 1, wherein the trial signal power at a first distance is first calculated by de-rotating a phase of a signal path at the first distance from the autocorrelated channel frequency response to obtain a de-rotated frequency response.

3. The method of claim 2, wherein the trial signal power at the first distance is computed by squaring an absolute mean value of the de-rotated frequency response at the plurality of frequencies.

4. The method of claim 2, wherein the total power of the autocorrelated channel frequency response is calculated as a mean of an absolute value of the autocorrelated channel frequency response at each of the plurality of frequencies, squared.

5. The method of claim 1, wherein the two wireless network devices comprise Bluetooth network devices.

6. The method of claim 1, wherein if the slope of the ramp is steep, the distance is defined as a first peak in the power ratio.

7. The method of claim 6, wherein the power ratio is calculated at a plurality of distances and the first peak is defined as a peak having a magnitude greater than a threshold at a smallest distance.

8. The method of claim 1, wherein if the slope of the ramp is steep, the distance is determined using a phase-based approach.

9. The method of claim 1, wherein if the slope of the ramp is not steep, the distance is defined as a smallest distance where the cumulative power ratio exceeds a predetermined threshold.

10. A Bluetooth network, comprising:
a reflector device; and
an initiator device, comprising:
a Bluetooth network interface;
a processing unit; and
a memory device, wherein the memory device comprises instructions, which when executed by the processing unit, enable the initiator device to:
perform a Channel Sounding procedure at a plurality of frequencies to obtain a channel frequency response;
autocorrelate the channel frequency response to obtain a autocorrelated channel frequency response;
use the autocorrelated channel frequency response to generate a power ratio as a function of distance, wherein power ratio is defined as trial signal power divided by total power of the autocorrelated channel frequency response;
compute a cumulative power ratio as a function of distance using the power ratio;
identify a ramp in the cumulative power ratio; and
use a slope of the ramp, the power ratio and the cumulative power ratio to determine a distance between the reflector device and the initiator device.

11. The Bluetooth network of claim 10, wherein the trial signal power at a first distance is first calculated by de-rotating a phase of a signal path at the first distance from the autocorrelated channel frequency response to obtain a de-rotated frequency response, the trial signal power at the first distance is computed by squaring an absolute mean value of the de-rotated frequency response at the plurality of frequencies and the total power of the autocorrelated channel frequency response is calculated as a mean of an absolute value of the autocorrelated channel frequency response at each of the plurality of frequencies, squared.

12. The Bluetooth network of claim 10, wherein if the slope of the ramp is steep, the distance is defined as a first peak in the power ratio.

13. The Bluetooth network of claim 12, wherein the power ratio is calculated at a plurality of distances and the first peak is defined as a peak having a magnitude greater than a threshold at a smallest distance.

14. The Bluetooth network of claim 10, wherein if the slope of the ramp is steep, the distance is determined using a phase-based approach.

15. The Bluetooth network of claim 10, wherein if the slope of the ramp is not steep, the distance is defined as a smallest distance where the cumulative power ratio exceeds a predetermined threshold.

16. A method of calculating a distance between two wireless network devices, comprising:
performing a Channel Sounding procedure at a plurality of frequencies to obtain a channel frequency response;
using the channel frequency response to generate a power ratio as a function of distance, wherein power ratio is defined as trial signal power divided by total power of the channel frequency response;
computing a cumulative power ratio as a function of distance using the power ratio;
identifying a ramp in the cumulative power ratio; and
using a slope of the ramp, the power ratio and the cumulative power ratio to determine a distance between the two wireless network devices.

17. The method of claim 16, wherein the trial signal power at a first distance is first calculated by de-rotating a phase of a signal path at the first distance from the channel frequency response to obtain a de-rotated frequency response, wherein the trial signal power at the first distance is computed by squaring an absolute mean value of the de-rotated frequency response at the plurality of frequencies, and wherein the total power of the channel frequency response is calculated as a mean of an absolute value of the channel frequency response at each of the plurality of frequencies, squared.

18. The method of claim 16, wherein if the slope of the ramp is steep, the distance is defined as a first peak in the power ratio, wherein the power ratio is calculated at a plurality of distances and the first peak is defined as a peak having a magnitude greater than a threshold at a smallest distance.

19. The method of claim 16, wherein if the slope of the ramp is steep, the distance is determined using a phase-based approach.

20. The method of claim 16, wherein if the slope of the ramp is not steep, the distance is defined as a smallest distance where the cumulative power ratio exceeds a predetermined threshold.
